(19) United States
(12) Patent Application Publication
(10) Pub. No.: US 2002/0163099 A1
(43) Pub. Date: Nov. 7, 2002

(54) Spiral flow head assembly for polymer extrusion

(76) Inventor: Paul Hendess, Safety Harbor, FL (US)

Correspondence Address: BLANK ROME COMISKY & MCCAULEY, LLP, 900 17TH STREET, N.W., SUITE 1000, WASHINGTON, DC, 20006, US

(21) Appl. No.: 09/845,339

(22) Filed: May 1, 2001

(51) Int. Cl. B29C 47/20

(52) U.S. Cl. 264/209.1; 425/380; 425/467

(57) ABSTRACT

The present invention is directed to a method and apparatus for using a spiral flow assembly in a polymer extrusion process to make small diameter tubing for such items as wires, cables, and tubing. The invention comprises a mandrel inside of a housing, the mandrel having spiral grooves located on its external surface. A polymer melt is introduced into the housing through an ingress port and flows into and through the spiral grooves on the outside surface of the mandrel, in what is called “groove flow” or “channel flow.” As the polymer melt flows through the grooves or channels, the housing and mandrel begin to separate by either having the housing taper outwardly, becoming gradually larger in diameter along the axial distance of the mandrel or having the mandrel begin to taper inwardly, becoming gradually smaller in diameter along the axial distance of the mandrel. This allows the polymer, which was restricted to “channel flow,” to leak over the top of the walls that separate adjacent grooves, in what is called “leakage flow.”

### FIELD OF THE INVENTION

The present invention is directed to a method and apparatus for a spiral flow head assembly that is used to manufacture small diameter tubing for such items as wires and cables, the tubing being devoid of radial weld lines in its surface to resist breaking and cracking.

### BACKGROUND OF THE INVENTION

Spiral flow head assemblies for polymer extrusion were initially used in the blown film extrusion process industry to make plastic films for such products as grocery bags. More recently, the use of spiral flow head assemblies has been applied to the manufacturing of large diameter polyolefin pressure pipes, particularly for high-pressure gas pipes, to eliminate radial weld lines which are focal points for breaks and cracks. However, spiral flow head assemblies have not been used to make small diameter, annular or tubular extruded polymer products for such items as small diameter wires, cables, and tubing.

Currently, small diameter tubing is produced using a helicoid flow assembly that splits and rejoins a polymer flow, creating weld lines through the wall of the tubing. A polymer melt is typically introduced into a helicoid flow manifold through an ingress port, where it flows through channels on an outer surface of a mandrel and is split into several divergent flows by wedges located around the mandrel. The polymer flow is then rejoined downstream of the wedges, creating weld lines in the final product which are weak points in the polymer structure that are prone to breaking or splitting.

### SUMMARY OF THE INVENTION

The present invention is directed to a method and apparatus for using a spiral flow assembly in a polymer extrusion process to make small diameter tubing as well as insulation coating for such items as wires and cables. The invention comprises a mandrel inside of a housing, the mandrel having spiral grooves located on its external surface. A polymer melt is introduced into the housing through an ingress port and flows into and through the spiral grooves on the outside surface of the mandrel, in what is called “groove flow” or “channel flow.” As the polymer melt flows through the grooves or channels, the housing and mandrel begin to separate by either having the housing taper outwardly, becoming gradually larger in diameter along the axial distance of the mandrel or having the mandrel begin to taper inwardly, becoming gradually smaller in diameter along the axial distance of the mandrel. This allows the polymer, which was restricted to “channel flow,” to leak over the top of the walls that separate adjacent grooves, in what is called “leakage flow.”

Leakage flow yields two primary benefits. The first is increased gage control or uniformity in the axial flow about the annular flow diameters near the annular exit of a head assembly which allows thin-walled, multi-layered structures to be manufactured. The second is the elimination of radially oriented weld lines in the product wall which tend to be the focal points of failures.

### BRIEF DESCRIPTION OF THE DRAWINGS

FIG. 1 is a perspective view of a spiral flow head assembly;

FIG. 2A is a side cross-sectional view of a mandrel and a mandrel support die;

FIG. 2A-1 is a top view taken along line 2A1-2A1 of FIG. 2A showing a spider leg and a breaker plate embodiment of the mandrel support die;

FIG. 2B is a side cross sectional view of a mandrel and a screen pack die;

FIG. 2C is a side cross-sectional view of a mandrel and a side-fed die;

FIG. 2D is a side cross-sectional view of a mandrel and a spiral mandrel die;

FIG. 3 is a perspective cut-out view of a helicoid flow head assembly;

FIG. 4 is a perspective view of the helicoid flow mandrel of FIG. 3 without the housing; and

FIG. 5 is a perspective view of a spiral flow mandrel of the present invention.

### DETAILED DESCRIPTION OF THE PREFERRED EMBODIMENTS

The present invention will be set forth in detail with reference to the drawings, in which like reference numerals refer to like components throughout.

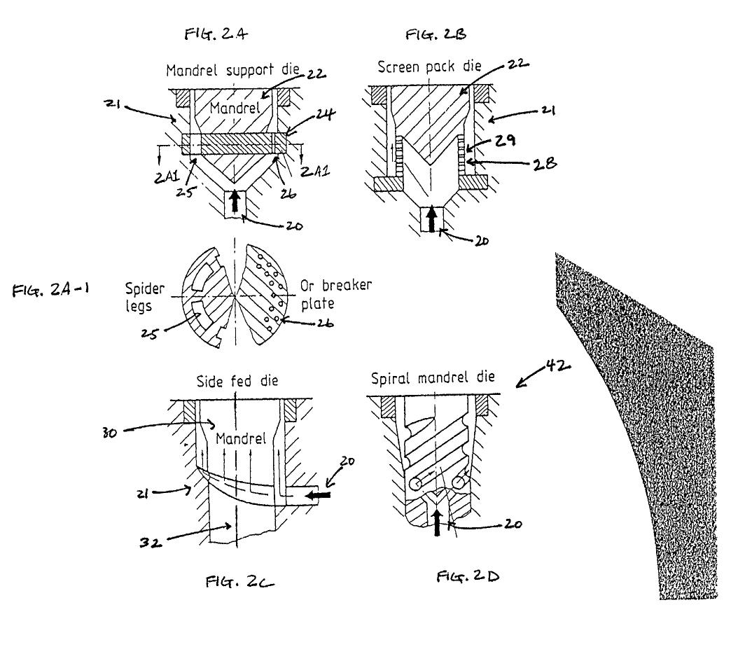

Typically, large diameter tubular or annular extruded product is produced by flowing a polymer melt around an inner mandrel that is supported within a housing by a mandrel support. FIGS. 2A-2D show various types of mandrel and mandrel support configurations. FIG. 2A shows a spider leg configuration and a strainer-basket configuration, FIG. 2B shows a screen pack configuration, FIG. 2C shows a side fed and FIG. 2D shows a spiral mandrel configuration.

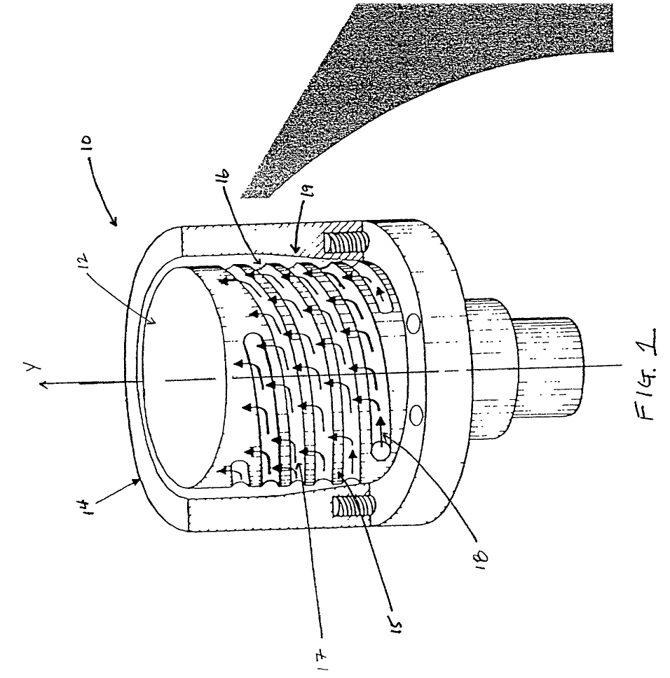

FIG. 2A shows a mandrel 22 and a mandrel support 24 in a housing 21. The mandrel support 24 includes openings 25 and 26 to allow the passage of the polymer melt around the mandrel 22, which is introduced into the housing 21 through ingress 20. FIG. 2A-1 shows a cross-sectional top view along line 2A1-2A1 of two alternative embodiments of the mandrel support 24 of FIG. 2A, showing the openings 25 and 26 in greater detail. The left half of FIG. 2A-1 shows a spider legged mandrel support having openings with a generally curved trapezoidal shape 25, and the right half of FIG. 2A-1 shows a perforated plate mandrel support having circular shaped openings 26. After the polymer melt has entered the housing 21, it flows around the mandrel 22 and passes the mandrel support 24, where it is separated into divergent flows by the openings 25 or 26.

FIG. 2B shows a mandrel 22 supported by a hollow cylindrical screen pack 28. The polymer melt enters the housing 21 at ingress 20, flowing through an interior passageway of the screen pack 28. The polymer then exits the passageway through openings 29 in the sides of the screen pack, which separates the polymer melt into several discrete flows.

FIG. 2C shows a mandrel 30 which extends past the ingress 20 of the polymer melt and is supported at its base (not shown). The polymer melt enters the housing 21 through an opening in a side wall flowing in a direction perpendicular to the axis 32 of the mandrel. As the polymer melt flows into the housing, portions of the polymer melt are forced to separate from the initial flow direction and begin to flow downstream, parallel to the axis 32 of the mandrel.

In FIGS. 2A to 2C, the polymer melt is separated, either by an obstruction, as in FIGS. 2A and 2B, or by intrinsic flow patterns as in FIG. 2C, into divergent flows which are later rejoined, and thus leading to the creation of weld lines in the final product. Although the weld lines can be eliminated by allowing the rejoined flow to stabilize and reach equilibrium, to do so would require the polymer melt to reside in the head assembly for long periods of time, which is impractical in most situations.

The polymer melt is composed of polymers which are long chain molecules that derive their strength from their natural, equilibrium molecular entanglements. Any time that a polymer flow is separated, or split by an obstruction, and then rejoined after the obstruction later in the flow channel, the earlier entanglements have been broken, and need time under pressure and temperature to return to an equilibrium, entangled condition. Usually the time needed to return to the equilibrium condition is much longer than what is acceptable in an extrusion head. So there remains a weld line effect, or weakness, in the wall structure of the extruded product in the radial direction, and extending along the length of the product, any time the melt flow has been split, then later rejoined.

FIG. 2D shows a spiral flow head assembly 42, similar to the head assembly of FIG. 1. A description of the operation of a spiral flow head assembly is given in reference to FIG. 1, but the same principles are applicable to the head assembly of FIG. 2D. FIG. 1 shows a spiral flow head assembly 10 comprising a spiral mandrel 12 and a die body or housing 14. A polymer melt, designated by the arrows 18, is introduced into the head assembly where it enters grooves or channels 16. Initially, the polymer melt 18 is restricted to flowing entirely within the grooves 16, in what is called “channel flow” or “groove flow,” being confined to the grooves by the housing 14. However, as the polymer melt moves through the grooves in the head assembly, the mandrel 12 and the housing 14 begin to separate such that either the inner diameter of the housing increases or the outer diameter of the mandrel decreases, creating a gap between the mandrel 12 and housing 14. FIG. 1 shows the interior wall 19 of the housing 14 sloping away from the mandrel and creating a gap between the mandrel 12 and the housing 14 so that the polymer melt can flow over the walls 15 separating the grooves, in what is called “leakage flow,” designated by curved arrows 17. Furthermore, as the axial distance Y along the mandrel increases, the depth of the grooves 16 decreases causing an increasingly larger portion of the polymer melt to be conducted in leakage flow, and an increasingly smaller portion to be conducted in channel flow.

There are two primary benefits of using a spiral flow mandrel to conduct polymer flow. The first is gage control, or an improvement in the uniformity of axial flow about the annular flow diameter near the exit of the head assembly. This allows better wall thickness control and stability, and reduces polymer usage. Furthermore, the polymer melt forms a partial helical polymer orientation that improves its physical and aesthetic properties, creating more stable, thinner walls for multi-layer tubes and coating structures.

The second benefit is the elimination of radially oriented weld lines in the structure of the product wall, the weld lines being created by using the other mandrel support methods. Most annular plastic products fail due to excessive internal pressure or hoop stresses, and the failure will be focused on one of the radial weld lines. The use of spiral mandrels for the polymer flow eliminates the preferential failure point, and slightly increases the normal burst pressure of the product in the non-weld line areas due to a partial helical orientation of the polymer chains that was imparted to the polymer during the channel flow in the spiral mandrel.

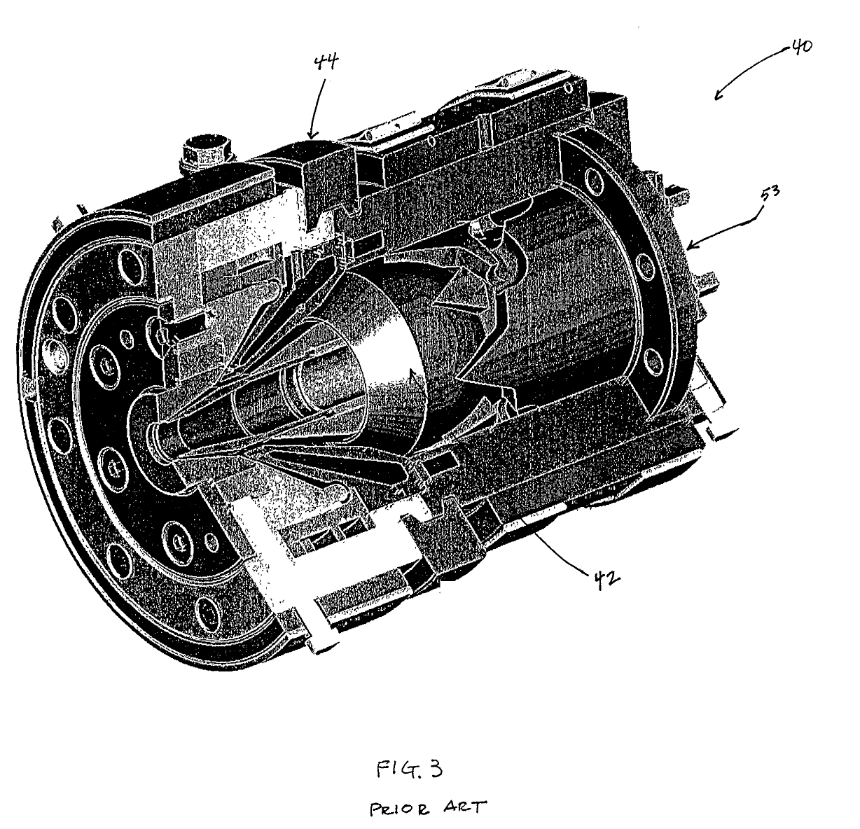

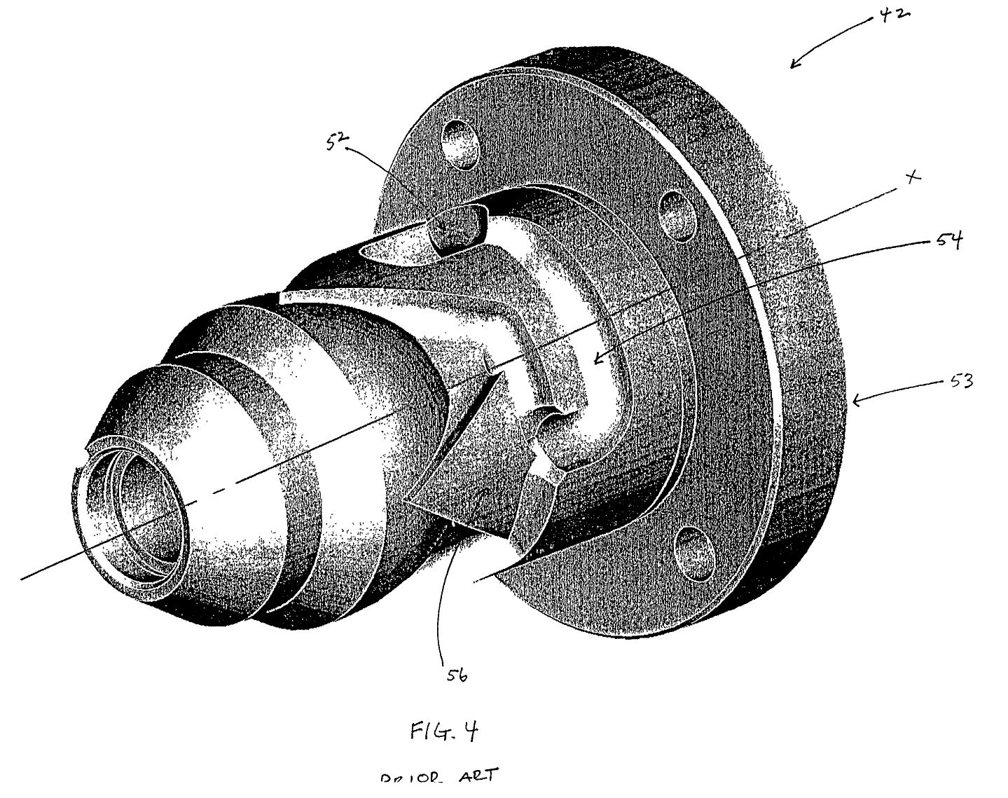

Currently small diameter tubing is manufactured using a helicoid flow head assembly, shown in FIGS. 3 and 4. FIG. 3 shows a basic helicoid flow head assembly 40 comprising a cone-shaped cylindrical mandrel 42 having a flanged base 53 within a housing 44. FIG. 4 shows the mandrel 42 without the cylindrical housing 44. Referring now to FIG. 4, a polymer melt is supplied to the helicoid head assembly 40 at ingress 52 in a direction perpendicular to the axis X of the mandrel 42. The melt then flows through the channels 54 and is split at two wedges 56 which are positioned on opposite sides of the mandrel's external surface. The polymer melt is then rejoined after having passed around the wedge 56 where it continues to flow downstream and out of the head assembly 40. With the flow separating and rejoining, a weld line is formed in the polymer melt, which typically does not have enough time in the head assembly to reach molecular equilibrium and remove the weld line effect.

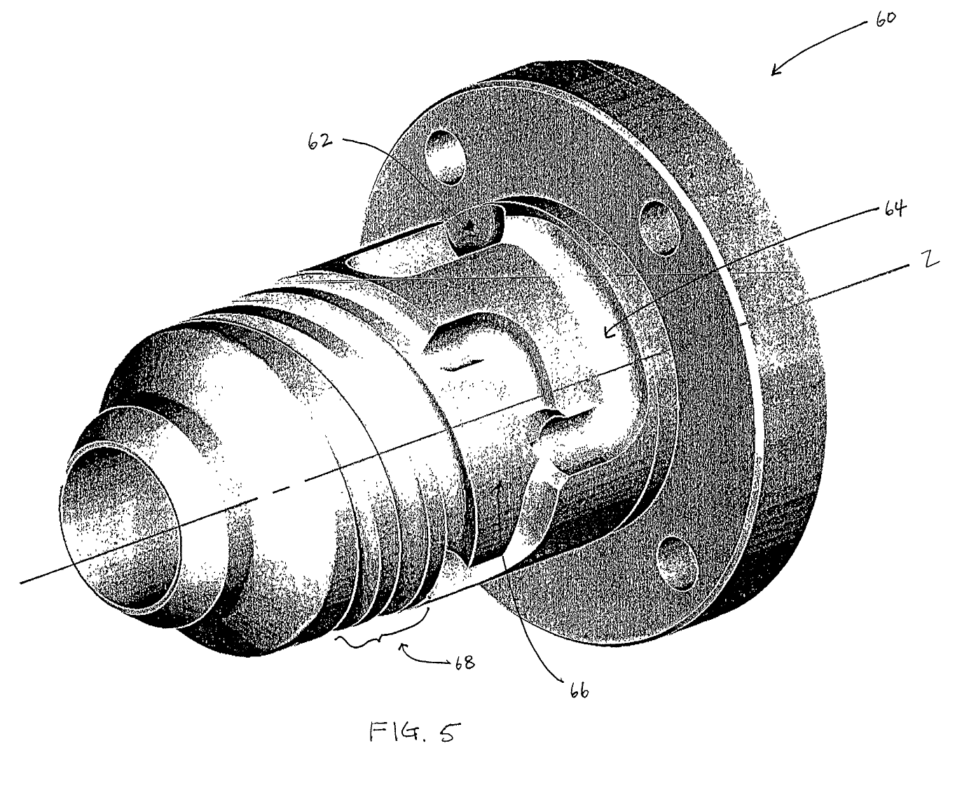

FIG. 5 shows a spiral mandrel 60 of the present invention to produce small diameter tubing or insulation for use in such products as wires, cables, pneumatic hoses, and catheters. The mandrel 60 is mounted within a housing, which housing is not shown in order to more clearly illustrate the path of the polymer melt along the mandrel's outer surface. The dimensions of the channels 68 and outer surface of the mandrel are sufficiently small to create small diameter tubing or insulation when the mandrel is mounted in a housing of a spiral flow head assembly. The polymer melt enters the channels 64 through an ingress port 62 in a direction perpendicular to the axis Z of the mandrel 60. The polymer melt is then split by a wedge 66 into divergent flows, which eventually enter spiral-shaped channels 68 in the outer surface of the mandrel 60. A similar wedge is located on the opposite side of the mandrel 60 and likewise splits the polymer melt into divergent flows. After passing around the wedges 66, the polymer melt enters the spiral channels 68 where it is conducted along the surface of the mandrel in channel flow. However, as the polymer melt moves within the spiral channels in the axial direction Z, it undergoes a transition from channel flow to leakage flow because either the inner diameter of the housing (not shown) increases or the outer diameter of the mandrel 60 decreases, separating the mandrel 60 from the housing. The transition to leakage flow facilitates the elimination of the weld line effects in the polymer melt created by the wedge 66.

The benefits of using a spiral flow head assembly to produce small diameter tubing or insulation include better wall thickness control and stability, better gage control resulting in reduced polymer usage, the elimination of radial weld lines for improved physical and aesthetic properties, and the formation of partial helical polymer walls for multi-layer tubing or coating structures. Another particularly important benefit in wire and cable manufacturing is the ability to bend or loop a coated conductor into very small bends or loops without having the polymer overcoat split along one of the weld lines. When a wire or cable is bent or tightly looped, the outer portion of the coating is significantly stretched and the inside portion of the coating is significantly compressed. These extreme deformations in opposing directions will often cause the coating to split along one of the weld lines and fail. The spiral flow head assembly allows one to produce a coating that is able to bend or loop into a very small bend or loop without having the polymer overcoat split along one of the weld lines. This kind of failure is similar to a pressure pipe bursting at one of the weld lines.

There are some considerations on the use of spiral flow head assemblies in polymer extrusion. Because the amount of flow channel surface area that is in contact with the polymer is greater in a spiral flow head assembly than with other types of head assemblies, the resulting pressure needed to flow the same amount of polymer is slightly higher. Also, because the flow channel volume in a spiral flow manifold is greater, and the flow channels are more intricate, the residence time and shear history of the polymer is usually increased over a conventional flow head. As a consequence, polymers that are thermally sensitive or shear sensitive may be more susceptible to heat or shear degradation in a spiral flow head assembly than in conventional flow heads, and this susceptibility should be taken into account.

Although only preferred embodiments are specifically illustrated and described herein, it will be appreciated that many modifications and variations of the present invention are possible in light of the above teachings departing from the spirit and intended scope of the invention.

What is claimed is:

1. A spiral flow head assembly for making small diameter tubing comprising:
a housing having an internal cavity; and
a mandrel located within the internal cavity having channels on its exterior surface for conveying a polymer melt, with at least a portion of the channels being spiral channels, said channels and said exterior surface dimensioned for small diameter tubing.

2. The spiral flow head assembly for making small diameter tubing of claim 1, wherein:
the mandrel has an ingress location where the polymer melt enters the channels, the polymer melt being initially conveyed along the channels in channel flow and then being converted to leakage flow.

3. The spiral flow head assembly for making small diameter tubing of claim 2, wherein:
the flow of the polymer melt is converted from channel flow to leakage flow by increasing the diameter of the housing so as to create a gap between the housing and the mandrel.

4. The spiral flow head assembly for making small diameter tubing of claim 2, wherein:
the flow of the polymer melt is converted from channel flow to leakage flow by decreasing the diameter of the mandrel so as to create a gap between the housing and the mandrel.

5. The spiral flow head assembly for making small diameter tubing of claim 1, wherein:
the mandrel includes at least one wedge located in the path of the channel to divert the polymer melt into separate flows; and
the spiral channels are located downstream of the wedge.

6. The spiral flow head assembly for making small diameter tubing of claim 5, wherein:
the polymer melt enters the spiral channels in channel flow, and is gradually converted to leakage flow while in the spiral channels.

7. The spiral flow head assembly for making small diameter tubing of claim 6, wherein:
a gap is created between the housing and the mandrel so as to allow the polymer melt in the spiral channels to leak over the walls of the spiral channels and undergo leakage flow and eliminate potential weld lines in the final product.

8. The spiral flow head assembly for making small diameter tubing of claim 6, wherein:
the depth of the spiral channels become increasingly more shallow along the mandrel in a direction of flow so as to increase the amount of polymer melt undergoing leakage flow.

9. A spiral flow head assembly for making small diameter tubing comprising:
a housing having an internal cavity and a mandrel located within the cavity, the mandrel having channels on its exterior surface for conveying a polymer melt;
wherein at least a portion of the channels are spiral shaped; and
the polymer melt enters the spiral shaped channel while in channel flow and is gradually converted to leakage flow therein.

10. The spiral flow head assembly for making small diameter tubing of claim 9, wherein:
the polymer melt initially enters non-spiral channels on the mandrel upstream of the spiral channel and is conveyed within the non-spiral channels under channel flow.

11. The spiral flow head assembly for making small diameter tubing of claim 10, wherein:
the dimensions of the housing and the mandrel are such that the housing and the mandrel begin to separate so as to allow the polymer melt in the spiral channel to leak over the walls of the spiral channels and undergo leakage flow to eliminate potential weld lines in the small diameter tubing.

12. The spiral flow head assembly for making small diameter tubing of claim 11, wherein:
the flow of the polymer melt is converted from channel flow to leakage flow by increasing the inner diameter of the housing so as to create a gap between the housing and the mandrel.

13. The spiral flow head assembly for making small diameter tubing of claim 11, wherein:
the flow of the polymer melt is converted from channel flow to leakage flow by decreasing the outer diameter of the mandrel so as to create a gap between the housing and the mandrel.

14. The spiral flow head assembly for making small diameter tubing of claim 12, wherein:
the depth of the spiral channels is increasingly more shallow along the mandrel in a flow direction so as to increase the amount of polymer melt undergoing leakage flow.

15. A mandrel for a spiral flow head assembly for making small diameter tubing comprising:
channels on an exterior surface of said mandrel for conveying a polymer melt, with at least part of the channels being spiral shaped, said channels and said external surface dimensioned for small diameter tubing.

16. The mandrel for a spiral flow head assembly for making small diameter tubing of claim 15 further comprising:
an ingress location on the mandrel where the polymer melt enters the channels, the polymer melt being initially conveyed along the channels in channel flow and then being converted to leakage flow.

17. The mandrel for a spiral flow head assembly for making small diameter tubing of claim 16 wherein:
the conversion from channel flow to leakage flow occurs in the spiral channels; and
the outer diameter of the mandrel is decreased so as to allow the polymer melt to flow over the walls of the channels and convert the polymer melt flow from channel flow to leakage flow.

18. The mandrel for a spiral flow head assembly for making small diameter tubing of claim 17 further comprising:
at least one wedge located in the path of the channel to divert the polymer melt into separate flows; and
the spiral channels being located downstream of the wedge.

19. The mandrel for a spiral flow head assembly for making small diameter tubing of claim 17 wherein:
the depth of the spiral channels becomes increasingly more shallow along the mandrel in a flow direction so as to increase the amount of polymer melt undergoing leakage flow.

20. A method for eliminating weld lines in small diameter tubing comprising the steps of:
flowing a polymer melt into channels on the outer surface of a mandrel, said channels and said outer surface dimensioned for small diameter tubing;
conveying the polymer melt through the channels in channel flow; and
converting the flow of the polymer melt from channel flow to leakage flow.

21. The method for eliminating weld lines in small diameter tubing of claim 20, wherein:
the conversion of the flow of the polymer melt from channel flow to leakage flow occurs in spiral channels on the mandrel.

22. The method for eliminating weld lines in small diameter tubing of claim 21, wherein:
the mandrel is located within a housing such that the channels in the mandrel are defined by the mandrel and the housing, and a gap is created between the mandrel and the housing to initiate the conversion from channel flow to leakage flow.

23. The method for eliminating weld lines in small diameter tubing of claim 20, wherein:
the mandrel has non-spiral channels and spiral channels;
conveying the polymer melt in channel flow along non-spiral channels on the mandrel; and then
flowing the polymer melt into spiral channels where the flow of the polymer melt is converted from channel flow to leakage flow.

24. The method for eliminating weld lines in small diameter tubing of claim 23, further comprising the step of:
separating the polymer melt flow into divergent flow paths using a wedge in the path of the non-spiral channels prior to the polymer melt entering the spiral channels.
